(19) United States
(12) Patent Application Publication
(10) Pub. No.: US 2006/0132631 A1
(43) Pub. Date: Jun. 22, 2006

(54) Hand shake compensation unit and image capturing apparatus

(75) Inventors: Masayuki Yoshii, Sakai-shi (JP); Tetsuya Ishizu, Osaka (JP); Yoshiyuki Mizumo, Osaka (JP); Shunji Oku, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/303,646

(22) Filed: Dec. 15, 2005

(30) Foreign Application Priority Data
Dec. 21, 2004 (JP) 2004-369025

(51) Int. Cl. H04N 5/335

(52) U.S. Cl. 348/294

(57) ABSTRACT

A hand shake compensation unit having a first substrate on which an image sensor is provided, a second substrate on which a processing circuit for processing an output signal from the image sensor is provided, a driving mechanism that drives the first substrate with respect to the second substrate, and a plurality of cable members that connects the first substrate with the second substrate and whose drawing directions on the first substrate are different from each other.

### CROSS-REFERENCE TO RELATED APPLICATION

This application is based on Japanese Patent Application No. 2004-369025 filed in Japan on Dec. 21, 2004, the entire content of which is hereby incorporated by reference.

### BACKGROUND OF THE INVENTION

1. Field of the Invention

The present invention relates to a hand shake compensation unit and an art associated therewith.

2. Description of the Related Art

For digital cameras (image capturing apparatuses), a CCD shift method is present as a method of reducing the influence of the user's hand shake. According to the CCD shift method, the CCD (image sensor) is relatively moved with respect to the taking optical system to thereby reduce the influence of the hand shake. In digital cameras, a hand shake compensation unit according to the CCD shift method or the like is incorporated, thereby realizing a hand shake compensation function.

In such a CCD shift method, the substrate where the CCD is mounted (also called CCD mount substrate) is driven for the hand shake compensation. In order to smoothly perform this driving, it is desired to reduce the weight of the CCD mount substrate to thereby reduce its inertia. To meet such a requirement, conventionally, an art has been proposed to provide a processing circuit that processes the output signal from the image sensor not on a substrate where the CCD is mounted but on an external substrate other than the substrate where the CCD is mounted. In this case, to transmit and receive signals outputted from the image sensor and the like, electric connection wiring (for example, flexible cable) is provided between the CCD mount substrate and the external substrate.

When the substrates are connected together by use of the flexible cable as described above, conventionally the wiring that outputs a plurality of signals is integrated into one cable member in consideration of the number of man-hours of assembly and the like. FIGS. 11 and 12 are views illustrating a case (conventional example) where two substrates are connected by one cable member. FIG. 11 is a side view of the case where two substrates are connected by one cable member. FIG. 12 is a plan view of the case where two substrates are connected by one cable member.

As shown in FIG. 11, a substrate (CCD mount substrate) 181 where a CCD 105 is mounted and an external substrate 182 are connected by one cable member (flexible cable) 186 through connectors 184 and 185.

However, since this cable member connects one substrate (CCD mount substrate) 181 with the other substrate (external substrate) 182 in a bending condition, a force caused by the bend (tensile force, etc.) acts on the CCD mount substrate 181. Because of the influence of such a force, while the CCD mount substrate can be moved with a comparatively small driving force in a certain direction (for example, +X direction), a comparatively large driving force is required to move the CCD substrate in the opposite direction (for example, −X direction). That is, the driving force for realizing the same driving differs according to the driving direction, so that stable driving cannot be performed.

### SUMMARY OF THE INVENTION

A principle object of the present invention is to provide a handshake compensation unit and an image capturing apparatus capable of performing stable driving of an image sensor for hand shake compensation.

The above-mentioned object of the present invention is attained by providing a hand shake compensation unit comprising: a first substrate on which an image sensor is provided; a second substrate on which a processing circuit for processing an output signal from the image sensor is provided; a driving mechanism that drives the first substrate with respect to the second substrate; and a plurality of cable members that connects the first substrate with the second substrate and whose drawing directions on the first substrate are different from each other.

The above-mentioned object of the present invention is also attained by providing an image capturing apparatus comprising: a taking optical system that directs a subject image to an image sensor; and a hand shake compensation unit that compensates for a blur of the subject image due to a hand shake in an image obtained by the image sensor, wherein the hand shake compensation unit comprises: a first substrate on which an image sensor is provided; a second substrate on which a processing circuit for processing an output signal from the image sensor is provided; a driving mechanism that drives the first substrate with respect to the second substrate; and a plurality of cable members that connects the first substrate with the second substrate and whose drawing directions on the first substrate are different from each other.

These and other objects, advantages and features of the invention will become apparent from the following description thereof taken in conjunction with the accompanying drawings, which illustrate specific embodiments of the invention.

### BRIEF DESCRIPTION OF DRAWINGS

These and other objects, advantages and features of the invention will become apparent from the following description thereof taken in conjunction with the accompanying drawings in which:

FIG. 1 is a cross-sectional view showing the structure of an image capturing apparatus according to a first embodiment of the present invention;

FIG. 2 is an exploded perspective view of a CCD moving unit in the image capturing apparatus of FIG. 1;

FIG. 3 is a functional block diagram of the image capturing apparatus;

FIG. 4 is a side view showing the condition of connection between a first and second substrates;

FIG. 5 is a plan view showing the first substrate;

FIG. 6 is a plan view showing the first substrate in an image capturing apparatus according to a second embodiment of the present invention;

FIG. 7 is a plan view showing the first substrate in an image capturing apparatus according to a third embodiment of the present invention;

FIG. 8 is a plan view showing the first substrate in an image capturing apparatus according to a fourth embodiment of the present invention;

FIG. 9 is a plan view showing the first substrate in an image capturing apparatus according to a fifth embodiment of the present invention;

FIG. 10 is a plan view showing the first. substrate in an image capturing apparatus according to a sixth embodiment of the present invention;

FIG. 11 is a side view showing the condition of connection between the two substrates in the conventional example of the present invention; and

FIG. 12 is a plan view showing the CCD mount substrate (first substrate) in the conventional example of the present invention.

### DESCRIPTION OF THE PREFERRED EMBODIMENTS

Hereinafter, embodiments of the present invention will be described with reference to the drawings.

### 1. First Embodiment

### SUMMARY

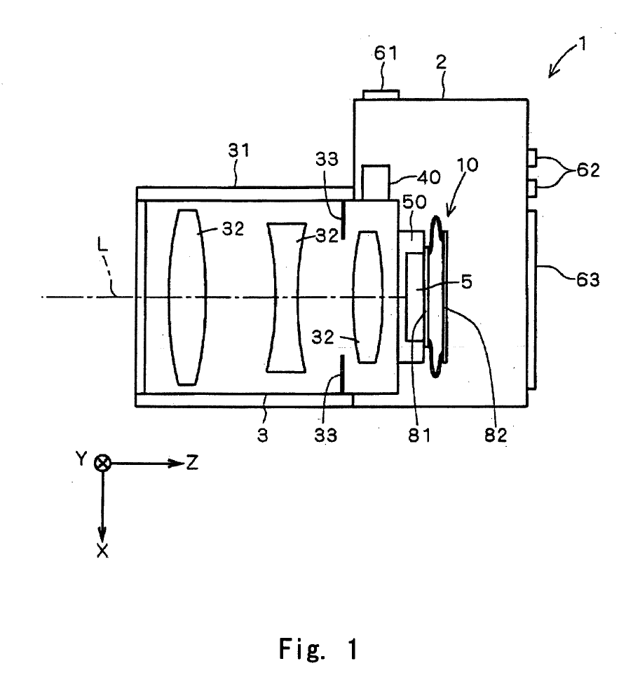

FIG. 1 is a cross-sectional view showing the principal structure of a digital camera as an image capturing apparatus according to a first embodiment of the present invention. The digital camera (more specifically, digital still camera) 1 has a hand shake compensation function for compensating for (suppressing) the blur of the subject image in the image due to a hand shake. As shown in the figure, the digital camera 1 mainly comprises a camera body 2, a taking lens (taking optical system) 3 fixedly provided on the camera body 2, and a hand shake compensation unit 10 fixedly provided in the camera body 2. In the description that follows, directions and the like are shown by using an XYZ three-dimensional rectangular coordinate system shown in the figure as appropriate. Here, the Z axis is provided along the optical axis L of the taking lens 3, the X axis is provided in the vertical direction, and the Y axis is provided in the horizontal direction (direction vertical to the plane of the figure). These X, Y and Z axes are relatively fixed with respect to the camera body 2.

The taking lens 3 mainly comprises a lens barrel 31, and a plurality of lens groups and a diaphragm 33 provided within the lens barrel 31. The taking lens 3 is structured as a zoom lens, and the focal length (photographing magnification) can be changed by changing the positions of the lens groups 32 in the direction of the Z axis. The light image of the subject formed through the taking lens 3 is captured on the image capturing surface of a CCD 5.

Behind the optical axis L of the taking lens 3 (on the positive side of the Z axis), the CCD 5 housed in the camera body 2 is disposed. The CCD 5 is an image sensor comprising fine pixels each of which is provided with a color filter, and photoelectrically converts the light image of the subject (subject image) formed by the taking lens 3, for example, into image signals having color components of R, G and B.

The hand shake compensation unit 10 comprises a CCD moving unit 50, a first substrate 81 and a second substrate 82. The first substrate 81 is a substrate to which the CCD 5 is fixed, and the second substrate 82 has a processing circuit that transmits and receives signals to and from he CCD 5 and performs various processings such as image processings. The connection between the first substrate 81 and the second substrate 82 will be described later in detail.

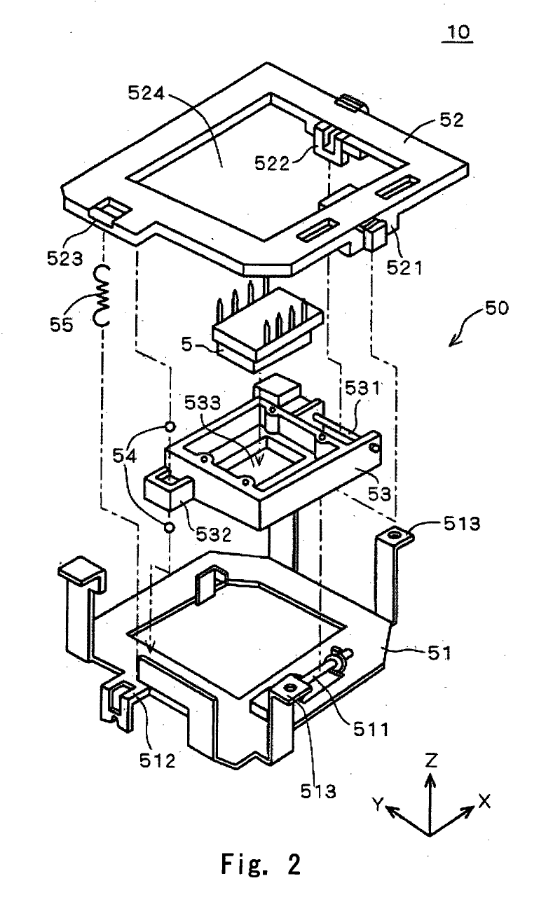

The CCD 5 is fixedly disposed within the CCD moving unit 50. The CCD 5 is movable within the XY plane perpendicular to the Z axis by the CCD moving unit 50. FIG. 2 is an exploded perspective view of the CCD moving unit 50 including the CCD 5.

As shown in FIG. 2, the CCD moving unit 50 mainly comprises the following three members: a base plate 51 fixedly provided in the camera body 2; a first slider 52 that moves in the direction of the X axis with respect to the base plate 51; and a second slider 53 that moves in the direction of the Y axis with respect to the first slider 52.

The base plate 51 has an opening in the center so that the incident light from the taking lens 3 can pass therethrough, and is provided with a first actuator 511 elongated in the direction of the X axis and a first spring hook 512 for hooking a spring 55. The second slider 53 has, in the center, an opening 533 where the CCD 5 can be fixed, and is provided with a second actuator 531 elongated in the direction of the Y axis and a rigid ball holder 532 where rigid balls 54 are loosely fit on both surfaces in the direction of the Z axis. The first slider 52 has an opening in the center. On the first slider 52, a first frictional coupler 521 is provided in a position opposed to the first actuator 511, a second frictional coupler 522 is provided in a position opposed to the second actuator 531, and a second spring hook 523 is provided in a position opposed to the first spring hook 512.

The first actuator 511 and the second actuator 531 are each provided with a piezoelectric element and a driving rod capable of driving in the direction of elongation, and the driving rod is moved by the amount and in the direction corresponding to the driving pulse applied to the piezoelectric element.

When the CCD moving unit 50 is assembled, the CCD 5 is fixedly provided so as to be fitted in the opening 533 of the second slider 53, the driving rod of the first actuator 511 and the first frictional coupler 521 are frictionally coupled together, and the driving rod of the second actuator 531 and the second frictional coupler 522 are frictionally coupled together. Moreover, the base plate 51 and the first slider 52 are pulled by the spring 55 in directions such that they approach each other. At this time, the second slider 53 is sandwiched between the base plate 51 and the first slider 52 through the rigid ball 54. By this, the base plate 51, the second slider 53 and the first slider 52 are disposed so as to be placed one on another in this order from the negative side to the positive side of the Z axis.

When the driving rod of the first actuator 511 is moved at low speed under a condition where such a CCD moving unit 50 is assembled, by the first frictional coupler 521 frictionally coupled thereto, the first slider 52 is moved in the direction of the X axis with respect to the base plate 51. At this time, the second slider 53 is also moved in the direction of the X axis with respect to the base plate 51 in response to the first slider 52. When the driving rod of the first actuator 511 is moved at high speed, the first slider 52 is stopped due to inertia. Moreover, when the driving rod of the second-actuator 531 is moved at low speed, by the second frictional coupler 522 frictionally coupled thereto, the second slider 53 is moved in the direction of the Y axis with respect to the first slider 52. At this time, since the movement of the first slider 52 with respect to the base plate 51 is not made, the second slider 53 alone is moved in the direction of the Y axis with respect to the base plate 51. When the driving rod of the second actuator 531 is moved at high speed, the second slider 53 is stopped due to inertia. That is, by the driving rods making to-and-fro movements (oscillation) at different speeds by the driving pulses applied to the piezoelectric elements, the second slider 53 is moved in the directions of the X and Y axes.

Moreover, as mentioned previously, since the base plate 51 is fixedly provided in the camera body 2 and the CCD 5 is fixedly provided on the second slider 53, the CCD 5 is relatively moved with respect to the camera body 2 within the XY plane. By this, the relative positions of the light image formed by the taking lens 3 and the CCD 5 can be changed, so that hand shake compensation can be performed.

Referring again to FIG. 1, inside the camera body 2, a shake sensor 40 is provided that detects the shake of the digital camera 1 due to a hand shake. The shake sensor 40 is provided with two angular velocity sensors (a first angular velocity sensor and a second velocity sensor). The angular velocity of the rotational shake with respect to the Y axis is detected by the first angular velocity sensor, and the angular velocity of the rotational shake with respect to the X axis is detected by the second angular velocity sensor. By the CCD 5 being moved in each of the directions of the X and Y axes based on the two angular velocities detected by the shake sensor 40, the correction of the blur of the subject in the image, that is, the hand shake correction is made.

A shutter button 61 is provided on the upper surface of the camera body 2. The shutter button 61, which is a button that accepts an instruction to start photographing preparations or perform image capturing (start exposure) from the user, is a two-stroke push button switch a half depressed condition (hereinafter, referred to also as S1 condition) and a fully depressed condition (hereinafter, referred to also as S2 condition) of which can be detected.

On the back surface of the camera body 2, an operation button 62 and an LCD 63 are provided. The operation button 62 accepts various instructions and settings of the digital camera 1 from the user. By performing a predetermined operation with the operation button 62, the user can, for example, provide an instruction to obtain centering information or set the focal length of the taking lens 3.

The LCD 63 displays various pieces of information and images. In the photographing standby state, the LCD 63 functions as a viewfinder that displays the images obtained by the CCD 5 at predetermined time intervals (live view display) and lets the user perform framing while confirming the subject image. In the present application, the images for preview used for framing and the like will be referred to as “live view images,” and the images obtained as images for recording in response to the depression of the shutter button 61 to the full depression. condition S2 will be referred to also as “actual photographing images.”

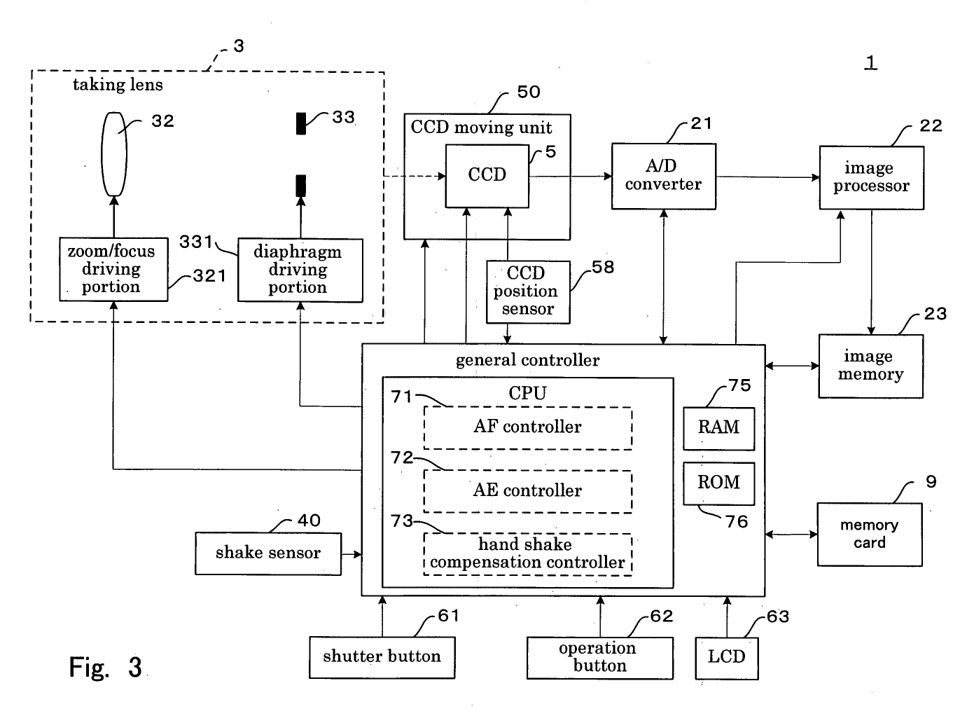

In the camera body 2, a memory card 9 (see FIG. 3) recording various pieces of data can be inserted, and the images for recording (actual photographing images) obtained by the CCD 5 are recorded on the memory card 9.

<Functional Blocks>

Various functions of the digital camera 1 including the hand shake compensation function and the centering information obtaining function are performed based on the control by a general controller provided in the camera body 2. FIG. 3 is a view showing the principal structure of the digital camera 1 including the general controller 7 as functional blocks.

As shown in FIG. 3, the processing portions of the digital camera 1 such as the CCD 5, the CCD moving unit 50, a CCD position sensor 58, the shake sensor 40, the shutter button 61, the operation button 62 and the LCD 63 are electrically connected to the general controller 7, and operate under the control by the general controller 7. Together therewith, the position of the CCD 5 detected by the CCD position sensor 58, the angular velocity detected by the shake sensor 40, the details of the operation of the shutter button 61, the details of the operation of the operation button 62 and the like are inputted to the general controller 7 as signals.

The taking lens 3 is provided with a zoom and focus driving portion 321 and a diaphragm driving portion 331. The zoom and focus driving portion 321 drives, as appropriate, the lens elements included in the lens groups 32 in the direction of the Z axis along the optical axis so that the focal length is the one set by the user or that in-focus state is obtained (focusing). Moreover, the diaphragm driving portion 331 adjusts the aperture diameter of the diaphragm 33 so that the aperture value is the one set by the general controller 7. The zoom and focus driving portion 321 and the diaphragm driving portion 331 are also electrically connected to the general controller 7, and operates under the control by the general controller 7.

Moreover, in FIG. 3, an A/D converter 21, an image processor 22 and an image memory 23 are processing portions that handle the images obtained by the CCD 5. That is, the images of analog signals obtained by the CCD 5 are converted into digital signals by the A/D converter 21, undergo predetermined image processings by the image processor 22, and then, are temporarily stored in the image memory 23. The images stored in the image memory 23 are recorded onto the memory card 9 as images for recording or displayed on the LCD 63 as images for live view display. Various image processings on such images are performed based on the control by the general controller 7.

The general controller 7 comprises a microcomputer. That is, the general controller 7 is provided with a CPU 70 performing various computations, a RAM 75 serving as the work area for performing the computations and a ROM 76 storing control programs and the like, and centralizedly controls the operations of the processors of the digital camera 1 as described above. As the ROM 76 being a nonvolatile memory, for example, an EEPROM where data is electrically rewritable is adopted. By this, in the ROM 76, data is rewritable and even when the power is turned off, the contents of the data are retained.

The general controller 7 has various control functions such as automatic focusing control (AF control), automatic exposure control (AE control) and hand shake compensation control. The various functions of the general controller 7 are realized by the CPU 70 performing the computations according to the control programs prestored in the ROM 76. In FIG. 3, the functional portions (an AF controller 71, an AE controller 72, and a hand shake compensation controller 73) realizing the functions are shown for the sake of convenience.

The AF controller 71 functions when the shutter button 61 is half depressed by the user, and performs an evaluation value computation and the like for performing automatic focusing control of a hill-climbing method (also called a video method or a contrast method). In this example, with respect to the image component corresponding to a predetermined AF evaluation area within the image, the sum total of the absolute values of the differences between horizontally adjoining two pixels is calculated as the AF evaluation value (focusing evaluation value). Then, the AF controller 71 obtains the in-focus position by use of the AF evaluation value, and drives the taking lens 3 toward the in-focus position. In other words, the AF controller 71 realizes the automatic focusing control by adjusting the focus position of the taking lens 3 by use of the focusing evaluation value.

The AE controller 72 divides the image into a plurality of blocks, and calculates the AE evaluation value based on the representative brightness value of each block. The automatic exposure control is realized by use of the AE evaluation value.

Moreover, the general controller 7 performs control for realizing the hand shake compensation function. Specifically, based on the two angular velocities inputted from the shake sensor 40, the hand shake compensation controller 73 derives the amount of blur of the subject image due to a shake and the position to which the CCD 5 is to be moved which position corresponds to the direction of the blur (hereinafter, this position will be referred to as “destination position”).

The general controller 7 (the hand shake compensation controller 73) compares the current position (measurement position) of the CCD 5 obtained from the CCD position sensor 58 with the derived destination position (target position) to thereby derive the amount and the direction by and in which the CCD 5 is to be moved. Further, the general controller 7 generates a driving pulse corresponding to the derived movement amount and direction and transmits the driving pulse to the actuators 511 and 531 of the CCD moving unit 50 to thereby move the CCD 5 to the destination position. As described above, by performing a closed loop control to derive the destination position corresponding to the shake of the digital camera 1, compare the current position of the CCD 5 with the destination position and successively move the position of the CCD 5 to the destination position, the blur of the subject image in the image can be compensated for.

As described above, the CCD moving unit 50 functions as a hand shake compensation mechanism under the control by the general controller 7.

<Connection Between Substrates>

Hereinafter, the condition of connection between the first substrate 81 (more specifically, 81A) and the second substrate 82 in the hand shake compensation unit 10 will be mainly described.

Although not shown in FIG. 2, the first substrate 81 and the second substrate 82 are both disposed parallel to the XY plane and on the +Z side with respect to the first slider 52 (FIG. 2). Moreover, the second substrate 82 is disposed on the +Z side with respect to the first substrate 81.

Specifically, the connection pin of the CCD 5 is fixed to the corresponding position of the first substrate 81 through an opening 524 (see FIG. 2) of the first slider 52. The first substrate 81 is driven together with the CCD 5 as the second slider 53 moves in the X and Y directions as described above. On the other hand, the second substrate 82 is fixed to a connection portion 513 of the base plate 51.

Consequently, the same relative motion as the relative motion occurring between the CCD 5 and the base plate 51 occurs between the first substrate 81 and the second substrate 82.

Here, to smoothly perform the relative motion, it is desired to reduce the inertia (in other words, reduce the mass) of the first substrate 81. For this reason, of the processing circuits shown in FIG. 3, only a part of processing circuits (for example, the A/D converter 21) is provided on the first substrate 81 and the other processing circuits (for example, the processing circuits corresponding to the image processor 22 and the general controller 7) are provided on the second substrate 82.

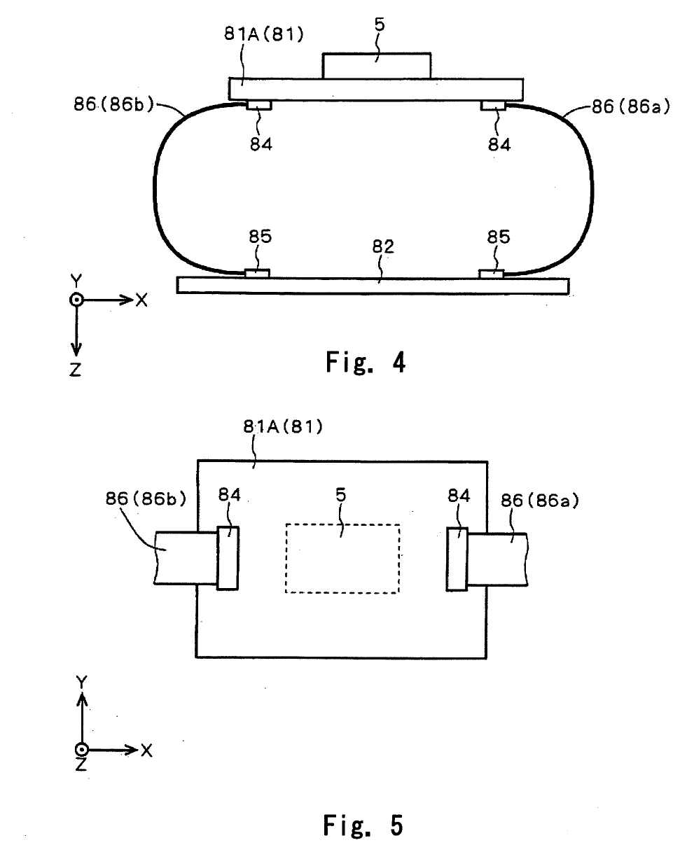

FIGS. 4 and 5 are views showing the condition of connection between the substrates 81A and 82. FIG. 4 is a view (side view) of the substrates 81 and 82 viewed from a side. FIG. 5 is a view (plan view) of the first substrate 81 from the back side (+Z side).

To transmit the output signal of the CCD 5 from the first substrate 81A to the second substrate 82 and to transmit the image capturing instruction to the CCD 5 and the like from the second substrate 82 to the first substrate 81A, two cable members 86 for connection are provided between the first substrate 81A and the second substrate 82. That is, the substrates 81 and 82 are electrically interconnected by the two cable members 86 for connection. As the cable members 86, flexible cable members are used. In this example, the cable members 86 are formed of flexible printed circuit boards (FPCs).

The CCD 5 is fixed to the principal plane, on the −Z side, of the first substrate 81A, and two connectors 84 are fixed to the principal plane, on the +Z side, of the first substrate 81A. Moreover, two connectors 85 are fixed to the principal plane, on the −Z side, of the second substrate 82. The connectors 84 have a connection function to electrically connect the cable members 86 and the substrate 81A, and the connectors 85 have a connection function to electrically connect the cable members 86 and the substrate 82.

The two connectors 84 are provided on the +X side (the right side in FIG. 5) and on the −X side (the left side in FIG. 5) with respect to the center on the +Z side principal plane of the substantially rectangular first substrate 81A. Likewise, the two connectors 85 are provided on the +X side and on the −X side with respect to the center on the −Z side principal plane of the substantially rectangular second substrate 82.

Then, as shown in FIG. 5, on the first substrate 81A, of the two cable members 86 (specifically, 86a and 86b) connected to the separate connectors 84, one cable member 86a is drawn out in the +X direction, and the other cable member 86b is drawn out in the −X direction. The cable member 86a drawn out from the +X side of the first substrate 81 in the +X direction is connected to the +X-side connector 85 of the second substrate 82 in a condition of being bent while being turned around the Y axis so that the front side and the back side are reversed. Moreover, the cable member 86b drawn out from the −X side of the first substrate 81 in the −X direction is connected to the −X-side connector 85 of the second substrate 82 in a condition of being bent while being turned around the Y axis so that the front side and the back side are reversed.

Here, the drawing directions of the two cable members 86a and 86b from the first substrate 81A are opposite to each other. In other words, the drawing direction of the cable member 86a and the drawing direction of the cable member 86b are at an angle of 180 degrees from each other. In the present embodiment, the “drawing direction” of the cable means the direction in which the cable is drawn out.

According to this structure, first, by dividing the cable member connecting the first substrate 81A and the second substrate 82 into a plurality of members (two cables in this example), the width of one cable member can be reduced. Consequently, the force that acts on the first substrate from one cable member due to a bend of the cable member can be reduced. Moreover, since the drawing directions of the plurality of cable members from the first substrate 81A are different from each other, the force that acts from each cable member can be dispersed, so that stable driving is enabled. In particular, in this embodiment, since the drawing directions of the two cable members 86a and 86b are opposite to each other, the forces that act on the first substrate 81A from the cable members 86a and 86b cancel out each other. Consequently, the balance of force is in an excellent condition, so that the first substrate 81A is enabled to stably operate with respect to the second substrate 82. Moreover, to create a more excellent condition, it is preferable that the two cable members 86 have the same width.

### 2. Second Embodiment

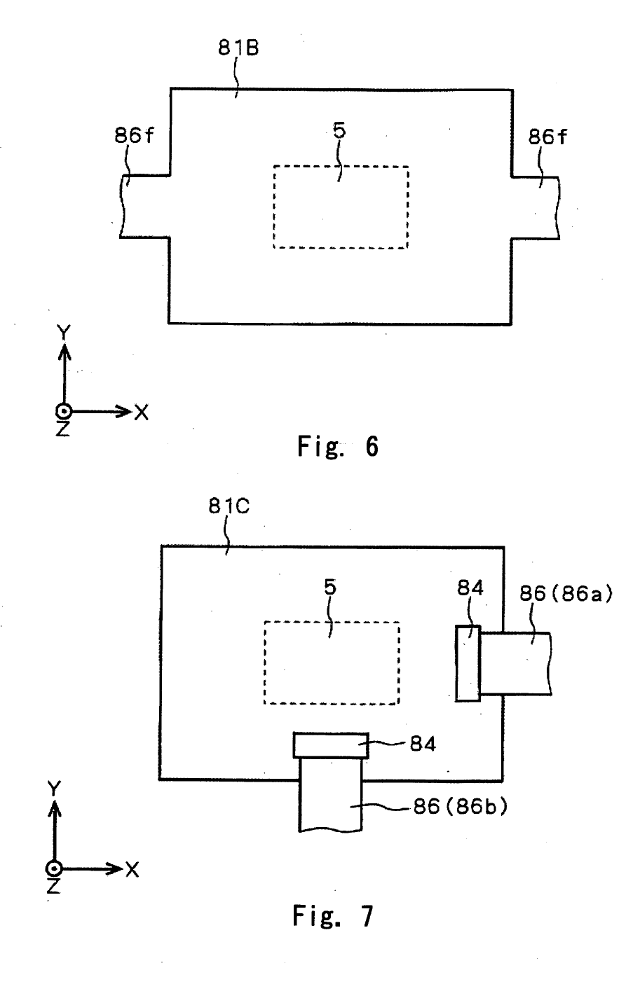

FIG. 6 is a plan view showing a first substrate 81B according to a second embodiment.

The second embodiment is a modification of the first embodiment, and is different from the first embodiment in that the first substrate 81B is provided instead of the first substrate 81A. Hereinafter, the difference from the first embodiment will be mainly described.

In the second embodiment, the first substrate 81B and two cable members 86f are previously integrally formed as a flexible printed circuit board.

The first substrate 81B, which corresponds to the first substrate 81A of the first embodiment, is formed as a flexible printed circuit board having a multilayer structure (multilayer FPC). The first substrate 81B is formed as a multilayer structure including a layer of a sheet material that enhances rigidity (for example, glass fiber), and has high rigidity.

The two cable members 86f, which correspond to the cable members 86 of the first embodiment, have similar structure and function to the cable members 86 of the first embodiment.

As described above, the first substrate 81B and the two cable members 86f are integrally formed as a flexible printed circuit board. The integral structure of the first substrate 81B and the two cable members (referred to also as wiring portions) 86f will be referred to also as first substrate member (with wiring portions).

The cable members 86f of the first substrate member are integrally formed with some layers of the multilayer structure of the first substrate 81B. Moreover, the ends of the cable members 86f are connected to the connectors 85 on the second substrate 82 like in the first embodiment.

According to the structure as described above, since it is unnecessary to provide the connectors 84 for connection on the first substrate 81B, the mass of the first substrate 81B can be reduced. Consequently, the inertia of the first substrate 81B is reduced, so that more stable driving can be realized.

### 3. Third Embodiment

The third embodiment is a modification of the first embodiment. In the third embodiment, a first substrate 81C is provided instead of the first substrate 81A. Hereinafter, the difference from the first embodiment will be mainly described.

FIG. 7 is a plan view showing the first substrate 81C according to the third embodiment.

Although the first substrate 81C has two connectors 84 like the first substrate 81A of the first embodiment, the positions of the connectors 84 are different. Specifically, the two connectors 84 are provided on the +X side (the right side in FIG. 7) and on the −Y side (the lower side in FIG. 7) with respect to the center on the +Z-side principal plane of the substantially rectangular substrate 81C. Moreover, in the third embodiment, the two connectors 85 are provided in the positions substantially opposed to the two connectors 84 on the second substrate 82. The cable member 86b drawn out in the −Y direction from the −Y side of the first substrate 81C is connected to the connector 85 provided on the −Y side of the second substrate 82 in a condition of being bent while being turned around the X axis so that the front side and the back side are reversed.

Then, of the two cable members 86 (specifically, 86a and 86b) connected to the separate connectors 84 on the first substrate 81C, one cable member 86a is drawn out in the +X direction from the +X side of the first substrate 81C, and the other cable member 86b is drawn out in the −Y direction from the −Y side of the first substrate 81C. That is, the drawing directions of the two cable members 86a and 86b are perpendicular to each other. Moreover, the cable member 86a and the cable member 86b are drawn out in the X direction (+X) and in the Y direction (−Y), respectively. In other words, the drawing directions of the two cable members 86a and 86b coincide with the driving axes (the X axis and the Y axis) of the driving actuator, respectively.

According to the structure as described above, by dividing the cable connecting the first substrate 81C and the second substrate 82 into a plurality of members, the width of one cable member can be reduced. Consequently, the force that acts on the first substrate from one cable member due to a bend of the cable member can be reduced. Moreover, since the drawing directions of the plurality of cable members are different from each other, the force that acts from each cable member can be dispersed, so that stable driving is enabled. In particular, in this embodiment, since the drawing directions of the two cable members 86a and 86b are perpendicular to each other, the directions of the forces that act on the first substrate 81C from the cable members 86a and 86b are independent of each other. More specifically, the drawing direction of the cable member 86a coincides with the direction of the X axis, and the drawing direction of the cable member 86b coincides with the direction of the Y axis. Consequently, the force from the cable members acts in a condition of being divided into two independent directions, the influence of the force that acts in one direction (for example, the X direction) can be reduced compared to when a large force acts only in one direction. As a result, the driving force for realizing the operation involving a desired acceleration can be suppressed in the direction (X direction).

### 4. Fourth Embodiment

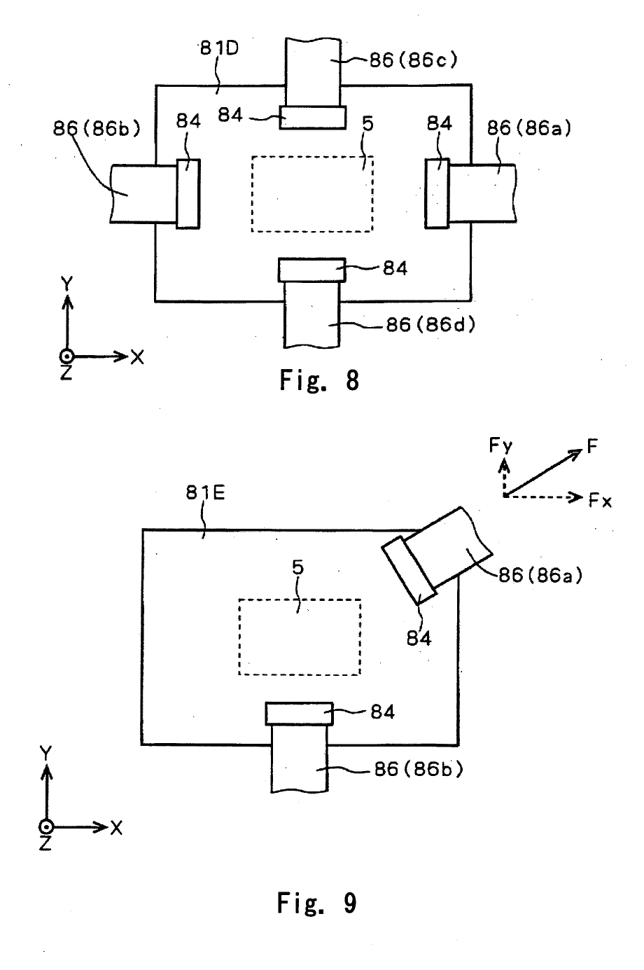

The fourth embodiment is a modification of the first embodiment. In the fourth embodiment, a first substrate 81D is provided instead of the first substrate 81A. Hereinafter, the difference from the first embodiment will be mainly described. FIG. 8 is a plan view showing the first substrate 81D according to the fourth embodiment.

The first substrate 81D has four connectors 84. These four connectors 84 are disposed on the +X side (the right side in FIG. 8), on the −X side (the left side in FIG. 8), on the +Y side (the upper side in FIG. 8) and on the −Y side (the lower side in FIG. 8) with respect to the center on the +Z-side principal plane of the substantially rectangular substrate 81D. In the fourth embodiment, on the second substrate 82, four connectors 85 are provided in positions substantially opposed to the four connectors 84.

Of four cable members 86 (specifically, 86a to 86d) connected to the separate connectors 84 on the first substrate 81D, the cable member 86a is drawn out in the +X direction, and the cable member 86b is drawn out in the −X direction. Moreover, the cable member 86c is drawn out in the +Y direction, and the cable member 86d is drawn out in the −Y direction.

That is, the drawing directions of the two cable members 86c and 86d are opposite to each other, and the drawing directions of the two cable members 86a and 86b are also opposite to each other. Moreover, the drawing directions of the cable members 86a and 86c are perpendicular to each other, and the drawing directions of the cable members 86b and 86d are also perpendicular to each other.

According to this structure, by dividing the cable connecting the first substrate 81D and the second substrate 82 into four members, the width of one cable member can be reduced. Consequently, the force that acts on the first substrate from one cable member due to a bend of the cable member can be reduced. Moreover, since the drawing directions of the plurality of cable members are different from each other, the force that acts from each cable member can be dispersed, so that stable driving is enabled.

In particular, in this embodiment, since the drawing directions of the two cable members 86a and 86b are opposite to each other, the forces that act on the first substrate 81D from the cable members 86a and 86b cancel out each other. Moreover, since the drawing directions of the two cable members 86c and 86d are opposite to each other, the forces that act on the first substrate 81D from the cable members 86c and 86d cancel out each other. Consequently, the balance of force is in an excellent condition, so that the first substrate 81D is enabled to stably operate with respect to the second substrate 82.

Moreover, in this embodiment, since the drawing directions of the cable members 86a and 86c are perpendicular to each other, the directions of the forces that act on the first substrate 81D from the cable members 86a and 86c are independent of each other. More specifically, the drawing directions of the cable members 86a and 86b coincide with the direction of the X axis (the +X direction and the −X direction), and the drawing directions of the cable members 86c and 86d coincide with the direction of the Y axis (the +Y direction and the −Y direction). Consequently, the force from the cable members acts in a condition of being divided into two independent directions, the influence of the force that acts in one direction (for example, the X direction) can be reduced compared to when a large force acts only in one direction. As a result, the driving force for realizing the operation involving a desired acceleration can be suppressed in the direction (X direction).

### 5. Fifth Embodiment

The fifth embodiment is a modification of the first embodiment. In the fifth embodiment, a first substrate 81E is provided instead of the first substrate 81A. Hereinafter, the difference from the first embodiment will be mainly described.

FIG. 9 is a plan view showing the first substrate 81E according to the fifth embodiment.

The first substrate 81E has two connectors 84. These two connectors 84 are disposed on the upper right side and on the lower side in FIG. 9 with respect to the center on the +Z side principal plane of the substantially rectangular substrate 81E. In the fifth embodiment, on the second substrate 82, two connectors 85 are provided in positions substantially opposed to the two connectors 84.

Of two cable members 86 (specifically, 86a and 86b) connected to the separate connectors 84 on the first substrate 81E, the cable member 86a is drawn out toward the upper right in FIG. 9 in a slanting direction, and the cable member 86b is drawn out toward the lower side in FIG. 9. In other words, the drawing direction of the cable member 86a and the drawing direction of the cable member 86b are at an angle of larger than 90 degrees and smaller than 180 degrees from each other.

According to this structure, the force F that acts on the first substrate 81E from the cable member 86a can be considered as divided into an X component Fx and a Y component Fy, and of them, the Y component Fy and the force that acts on the first substrate 81E from the cable member 86b cancel out each other. Consequently, the balance of force in the Y direction improves. Moreover, of the force F, the X component Fx acts in a direction independent of the force that acts on the first substrate 81E from the cable member 86b. As a result, compared to when a large force acts only in one direction (for example, Y direction), the driving force for realizing the operation involving a desired acceleration can be suppressed in the direction (Y direction).

### 6. Sixth Embodiment

The sixth embodiment is a modification of the first embodiment. In the sixth embodiment, a first substrate 81F is provided instead of the first substrate 81A. Hereinafter, the difference from the first embodiment will be mainly described.

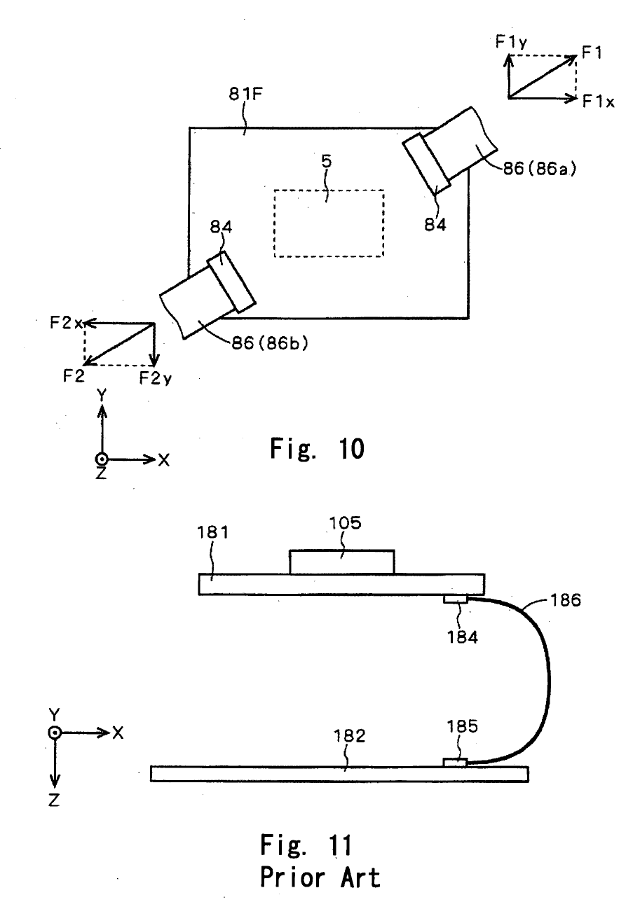

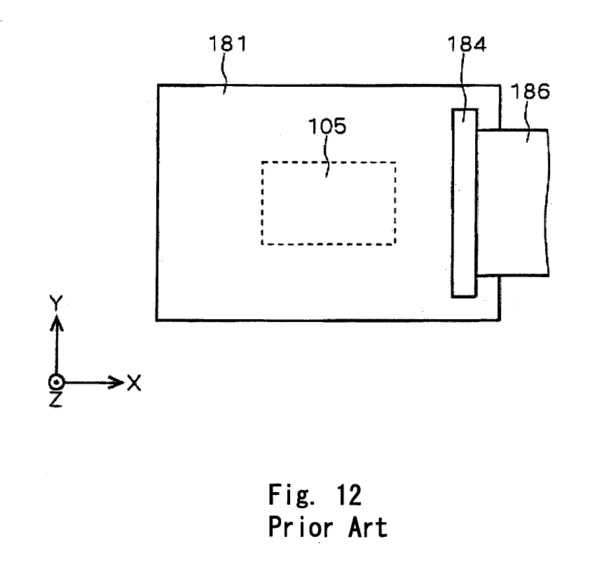

FIG. 10 is a plan view showing the first substrate 81F according to the sixth embodiment.

The first substrate 81F has two connectors 84. These two connectors 84 are disposed on the upper right side and on the lower left side with respect to the center on the +Z side principal plane of the substantially rectangular substrate 81F. In the sixth embodiment, on the second substrate 82, two connectors 85 are provided in positions substantially opposed to the two connectors 84.

Of two cable members 86 (specifically, 86a and 86b) connected to the separate connectors 84 on the first substrate 81F, the cable member 86a is drawn out toward the upper right in FIG. 10 in a slanting direction, and the cable member 86b is drawn out toward the lower left side in FIG. 10 in a slanting direction.

Here, the force F1 that acts on the first substrate 81F from the cable member 86a can be divided into an X component F1x and a Y component F1y, and the force F2 that acts on the first substrate 81F from the cable member 86b can be divided into an X component F2x and a Y component F2y. The Y component F1y and the Y component F2y cancel out each other, and the X component F1x and the X component F2x cancel out each other. Consequently, the balance of force between the Y direction and the X direction improves. Moreover, the forces F1 and F2 that act on the first substrate 81F from the cable members 86a and 86b act in a condition of being divided in two orthogonal driving shaft directions (the X direction and the Y direction). Consequently, compared to when a large force acts only in one driving shaft direction, the driving force for realizing the operation involving a desired acceleration can be suppressed in the direction.

<7. Others>

While the embodiments of the present invention are described above, the present invention is not limited to the contents described above.

While in the above-described embodiments, cases are shown where the processing circuits other than the processing circuits disposed on the first substrate 81 (81A to 81F) are disposed on the second substrate 82, the present invention is not limited thereto; some processing circuits disposed on the second substrate 82 in the embodiments may be disposed on another substrate (third substrate) different from both the first and second substrates.

While in the second embodiment, a case is shown where the first substrate and the plurality of cable members are integrally formed in the cable arrangement of the first embodiment, the present invention is not limited thereto. For example, in each of the cable member arrangements of the third to sixth embodiments, the first substrate and the plurality of cable members may be integrally formed as a flexible printed circuit board (FPC).

Further, while in the above-described embodiments, cases are shown where the drawing direction of a cable member and the drawing direction of another cable member are at an angle of not less than 90 degrees from each other, the present invention is not limited thereto. For example, two cable members may be disposed at an angle of 60 degrees.

Although the present invention has been fully described by way of examples with reference to the accompanying drawings, it is to be noted here that various changes and modifications will be apparent to those skilled in the art. Therefore, unless otherwise such changes and modifications depart from the scope of the present invention, they should be construed as being included therein.

What is claimed is:

1. A hand shake compensation unit comprising:
a first substrate on which an image sensor is provided;
a second substrate on which a processing circuit for processing an output signal from the image sensor is provided;
a driving mechanism that drives the first substrate with respect to the second substrate; and
a plurality of cable members that connects the first substrate with the second substrate and whose drawing directions on the first substrate are different from each other.

2. The hand shake compensation unit as claimed in claim 1, wherein the plurality of cable member include a first cable member and a second cable member, and drawing direction of the first cable member and drawing direction of the second cable member are at an angle of not less than 60 degrees.

3. The hand shake compensation unit as claimed in claim 1, wherein the plurality of cable members include a first cable member and a second cable member, and drawing direction of the first cable member is opposite to drawing direction of the second cable member.

4. The hand shake compensation unit as claimed in claim 1, wherein the plurality of cable members include a first cable member and a second cable member, and drawing direction of the first cable member is perpendicular to drawing direction of the second cable member.

5. The hand shake compensation unit as claimed in claim 4, wherein the first cable member and the second cable member are drawn respectively along a first driving shaft and a second driving shaft in the driving mechanism.

6. The hand shake compensation unit as claimed in claim 1, wherein the plurality of cable members include first to fourth cable members, drawing direction of the first cable member is opposite to the second cable member, drawing direction of the third cable member is opposite to drawing direction of the fourth cable member, drawing direction of the first cable member is perpendicular to drawing direction of the third cable member, and drawing direction of the second cable member is perpendicular to drawing direction of the fourth cable member.

7. The hand shake compensation unit as claimed in claim 1, wherein the plurality of cable members include a first cable member and a second cable member, and at least either of the first cable member and the second cable member is drawn in a direction slantindicular to a driving shaft provided in the driving mechanism.

8. The hand shake compensation unit as claimed in claim 1, wherein each of the plural cable members is formed of flexible printed circuit board.

9. The hand shake compensation unit as claimed in claim 1, wherein the first substrate and the plurality of cable members are integrally formed as a flexible printed circuit board.

10. The hand shake compensation unit as claimed in claim 1, further comprising:
a third substrate on which a second processing circuit for processing an output signal from the image sensor is provided.

11. An image capturing apparatus comprising:
a taking optical system that directs a subject image to an image sensor; and
a hand shake compensation unit that compensates for a blur of the subject image due to a hand shake in an image obtained by the image sensor, wherein the hand shake compensation unit comprises:
a first substrate on which an image sensor is provided;
a second substrate on which a processing circuit for processing an output signal from the image sensor is provided;
a driving mechanism that drives the first substrate with respect to the second substrate; and
a plurality of cable members that connects the first substrate with the second substrate and whose drawing directions on the first substrate are different from each other.
